(19) United States
(12) Patent Application Publication
(10) Pub. No.: US 2004/0048589 A1
(43) Pub. Date: Mar. 11, 2004

(54) Radio communication apparatus

(75) Inventors: Akio Yamamoto, Hiratsuka (JP); Katsuei Ichikawa, Yokohama (JP); Isao Ikuta, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/439,618

(22) Filed: May 16, 2003

(30) Foreign Application Priority Data
May 15, 2002 (JP) 2002-139409

(51) Int. Cl. H04B 1/00

(52) U.S. Cl. 455/130

(57) ABSTRACT

A radio communication apparatus for executing reliable communications is provided by detecting reception statuses of communication systems, and selecting one from the systems according to the detected reception statuses and power consumption.

### BACKGROUND OF THE INVENTION

The present invention relates to a radio communication apparatus for transmitting/receiving digitally-modulated signals.

JP-A No.13274/2000 (a first literature) discloses a dual mode radio communication apparatus using the WCDMA and PDC. In this apparatus, the transmission/reception terminal is downsized, lightened, and consumes less power by sharing the quadrature modulator and power control amplifier. JP-A No.103549/2001 (a second literature) discloses a communication terminal using the PDC and WCDMA, and a communication terminal using Bluetooth (the registered trademark of Ericsson) and consuming low power. In the network system of the second literature, communication using low power is preceded to reduce communication charges. “Tech. Rep. IEICE, CS2001-100, p.43” (a third literature) describes “Radio channel management in 2.4 GHz wireless LAN network”, where a communication frequency is dynamically changed in 2.4 GHz band to execute steady communication without receiving interference. Such prior arts relate to reception of a plurality of communication systems and to a communication method for avoiding interference.

### SUMMARY OF THE INVENTION

Frequency bands used in mobile phones and wireless LANs have become high. The communication speeds also become high so that power consumption of the transmitting/receiving terminals tends to increase. In an area where a plurality of communication systems exist as shown in FIG. 12, there is a need to select from the communication systems. It is important to select from them in consideration of their received signal-to-noise ratios and power consumption.

Additionally, power consumption increases because of the interference from the plurality of communication systems. The power saving is thus required.

The first literature describes that a plurality of communication systems share a transmitting/receiving circuit, but does not describe a method for selecting from the communication systems and a method for saving their power consumption. A low-powered communicating portion of the second literature always operate. The second literature does not describe the selection of the communication systems either. The third literature describes the receiving abilities stabilized by changing frequencies within the 2.4 GHz band, but, same as the first literature, it does not describe a method for saving their power consumption.

To provide a radio communication apparatus for executing reliable communication, reception statuses of communication systems are detected, and a communication system is selected from a plurality of ones according to the detected reception statuses and power consumption.

Other and further objects, features and advantages of the invention will appear more fully from the following description.

### BRIEF DESCRIPTION OF THE DRAWINGS

FIG. 1 is a block diagram showing a radio communication apparatus of a first embodiment;

FIG. 2 is a block diagram showing a demodulation processing portion of the radio communication apparatus of the first embodiment;

FIG. 3 shows the timing that the radio communication apparatus of the first embodiment detects signal-to-noise ratios;

FIG. 4 is an operation flowchart of communication of the first embodiment;

FIG. 5 is a block diagram showing a configuration of a radio communication apparatus of a second embodiment;

FIG. 6 is an operation flowchart of the second embodiment;

FIG. 7 is a block diagram showing a configuration of a third embodiment;

FIG. 8 is an operation flowchart of a radio communication apparatus of the third embodiment;

FIG. 9 is a block diagram showing a radio communication apparatus of a forth embodiment;

FIG. 10 is a block diagram showing a configuration of a radio communication apparatus of a fifth embodiment;

FIG. 11 is a block diagram showing a configuration of a radio communication apparatus of a sixth embodiment; and

FIG. 12 is an explanatory diagram of a reception area.

### DETAILED DESCRIPTION OF THE PREFERRED EMBODIMENTS

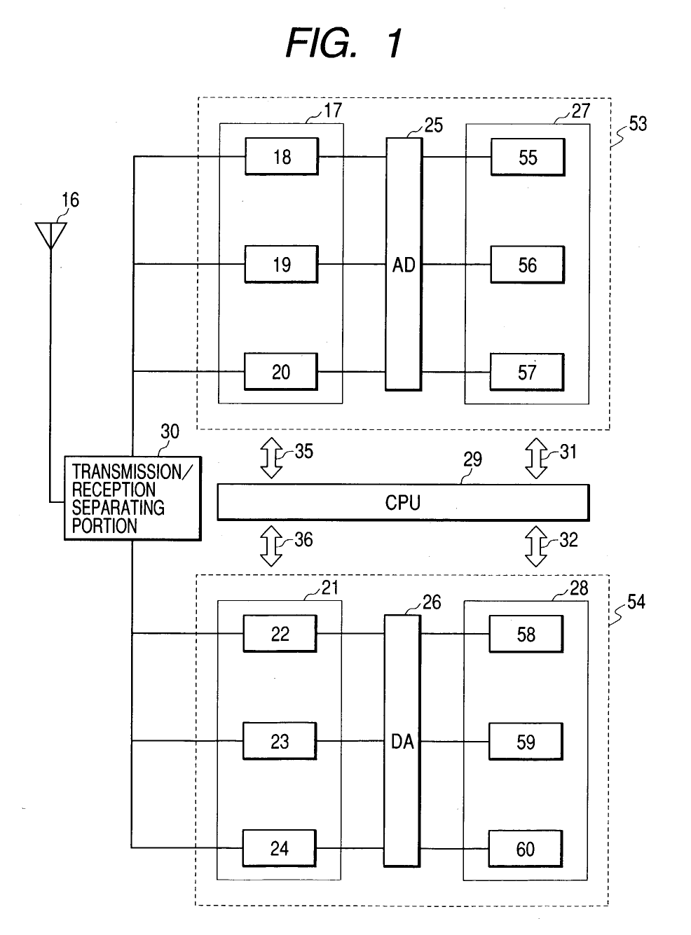

Preferred embodiments will be explained in the following with reference to FIGS. 1 to 12.

As for mobile phones, in addition to the second generation mobile system such as PDC and GSM, the third mobile system (IMT-2000) such as WCMA and cdma2000 has been standardized. The forth generation mobile system having a high transmission rate is under study. As for wireless LANs, IEEE802.11b and IEEE802.11g using the 2.4 GHz band and IEEE 802.11a using the 5 GHz band have started to be used at indoor and outdoor hotspots. In this way, many radio communication systems are in-service or ready for service. As a result, a terminal for communicating with a plurality of communication systems is required.

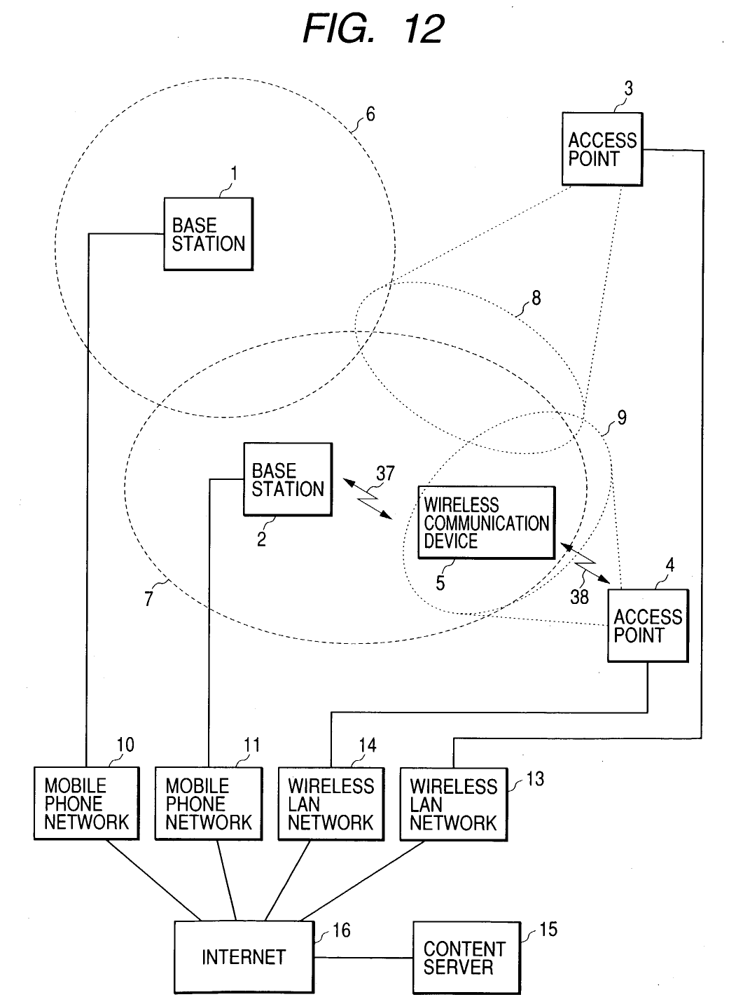

FIG. 12 shows an example of an area where a plurality of communication systems exist. Base stations 1 and 2 are ones for cellular type mobile phones, and have large communication areas 6 and 7. The base stations 1 and 2 use different communication systems such as the WCDMA and fourth generation mobile system. Access points 3 and 4 are ones for-wireless LANs and have relatively narrow communication areas 8 and 9 used at hotspots. The access points 3 and 4 use different communication systems such as IEEE802.11a and IEEE802.11g.

The base stations 1 and 2 and access points 3 and 4 are connected to the Internet 16 over mobile phone networks 10 and 11 and wireless LAN networks 13 and 12, respectively, and provide data from a content server 15 to terminals. In FIG. 12, a radio communication apparatus 5 can receive signals from a communication system 37 of the base station 2 and from a communication system 38 of the access point 4.

A radio communication apparatus of this embodiment comprises a transmitting/receiving portion corresponding to a plurality of communication systems, and detects from the systems reception statuses including received signal-to-noise ratios, power consumption amounts, remaining battery charged amounts, input signal amplitudes, and output signal amplitudes. The radio communication apparatus transmits/receives data by use of a communication system achieving the best reception status according to the detected reception statuses.

A first embodiment will be explained with reference to FIGS. 1 to 4. A radio communication apparatus of this embodiment comprises an antenna 16 for transmitting/receiving signals, a transmission/reception separating portion 30 for separating transmission/reception signals, a receiving portion 53 for receiving signals from a plurality of communication systems, a transmitting portion 54 for transmitting signals to a plurality of communication systems, and a CPU portion 29 for controlling the receiving portion 53 and transmitting portion 54.

A high frequency signal received through the antenna 16 is selected in the transmission/reception separating potion 30, and input to the receiving portion 53. A signal from the transmitting portion 54 is selected in the transmission/reception separating potion 30, and transmitted through the antenna 16. When a transmission/reception signal multiplexing method of the communication system is FDMA (Frequency Division Multiplex Access), the transmission/reception separating potion 30 has a filtering function for separating transmission/reception signal bands. When a transmission/reception signal multiplexing method of the communication system is TDMA (Time Division Multiplex Access), the transmission/reception separating potion 30 has a function for switching transmission/reception signals. The radio communication apparatus of this embodiment detects received signal-to-noise ratios of a plurality of communication systems, and selects and communicates with a communication system having the highest received signal-to-noise ratio.

First, the receiving portion 53 will be explained. The receiving portion 53 comprises an analog high frequency portion 17, an AD converter 25, and a demodulation processing portion 27. The analog high frequency portion 17 is provided with high frequency signal processing portions 18, 19 and 20 for corresponding to three communication systems. The CPU 29 switches, by use of a control signal 35, the high frequency signal processing portions 18, 19 and 20 according to a receiving communication system.

An output of the analog high frequency portion 17 is converted to a digital signal in the AD converter 25, and input to the demodulating portion 27. The demodulating portion 27 comprises demodulating portions 55, 56 and 57 corresponding to the communication systems. The CPU 29 switches, by use of a control signal 31, the demodulating portions 55, 56 and 57 according to a receiving communication system. Each of the demodulating portions 55, 56 and 57 comprises, e.g., a digital filter, a synchronously-reproducing portion and a SN detecting portion to thereby execute demodulation and detect received signal-to-noise ratios of the communication systems.

Next, a transmitting portion 54 will be explained in the following. The transmitting portion 54 comprises a modulation processing portion 28, a DA converter 26, and a high frequency transmitting portion 21. The modulation processing portion 28 is provided, for corresponding to the communication systems, with modulating portions 58, 59 and 60 which the CPU 29 switches by use of a control signal 32 according to the transmitting communication system. An output of a modulation processing portion 32 is converted to an analog signal in the DA converter 26, and input into the high frequency,transmitting portion 21. A high frequency transmitting portion 36 is provided with transmitting portion 22, 23 and 24, which the CPU 29 switches by use of the control signal 36 according to the transmitting communication systems. An output signal from the high frequency transmitting portion 21 is transmitted via a transmission/reception separating portion 30 through the antenna 16.

In this embodiment, the demodulating portions 55, 56 and 57 detect received signal-to-noise ratios of the communication systems, and the circuit portions corresponding to the communication system having the highest signal-to-noise ratio execute transmission/reception. In other words, the control bus 35 switches the high frequency signal processing portions 18, 19 and 20, the control bus 31 switches the demodulating portions 55, 56 and 57, the control bus 32 switches the modulating portions 58, 59 and 60, and the control bus 36 switches the transmitting portions 22, 23 and 24 in order to select the circuit portions corresponding to the communication system having the highest received signal-to-noise ratio.

According to this embodiment, the CPU 29 selects the communication system having the highest received signal-to-noise ratio, and reliable communication is achieved using the selected communication system.

FIG. 2 shows a configuration of the demodulation processing portion 27 of the first embodiment. Three communication systems A, B, C are provided. The demodulation processing portion 27 comprises the demodulating portion 55 for demodulating the communication system A, the demodulating portion 56 for demodulating the communication system B, the demodulating portion 57 for demodulating the communication system C, and a comparator 45 for comparing signal-to-noise ratios of the communication systems. The demodulating portion 55 comprises a synchronous demodulation portion 39, a received signal-to-noise ratio detecting portion 42, and a filter 67. The demodulating portion 56 comprises a synchronously-demodulating portion 40, a received signal-to-noise ratio detecting portion 43, and a filter 68. The demodulating portion 57 comprises a synchronously-demodulating portion 41, a received signal-to-noise ratio detecting portion 44, and a filter 69.

The comparator 45 compares the results of signal-to-noise ratios detected in the received signal-to-noise ratio detecting portions 42, 43 and 44, and judges the communication system having the highest signal-to-noise ratio. The judgment data is input into the CPU 29 via the control bus 31. According to the judgment data, the CPU 29 selects the demodulating portion for the communication system selected by control bus 31, the high frequency signal processing portion for the communication system selected by control bus 35, the modulating portion for the communication system selected by control bus 32, and the transmitting portion for the communication system selected by control bus 36.

When a cellular type mobile phone is used as the communication system, an area signal continuously transmitted from the base station is received, and the received signal-to-noise ratio can be detected from the area signal. When a wireless LAN is used as the communication system, a challenge text which is transmitted from an access point in response to authentication requirement from a terminal is received, and the received signal-to-noise ratio can be detected from the challenge text. The received signal from which the received signal-to-noise ratio is detected is not limited to the area signal and challenge text.

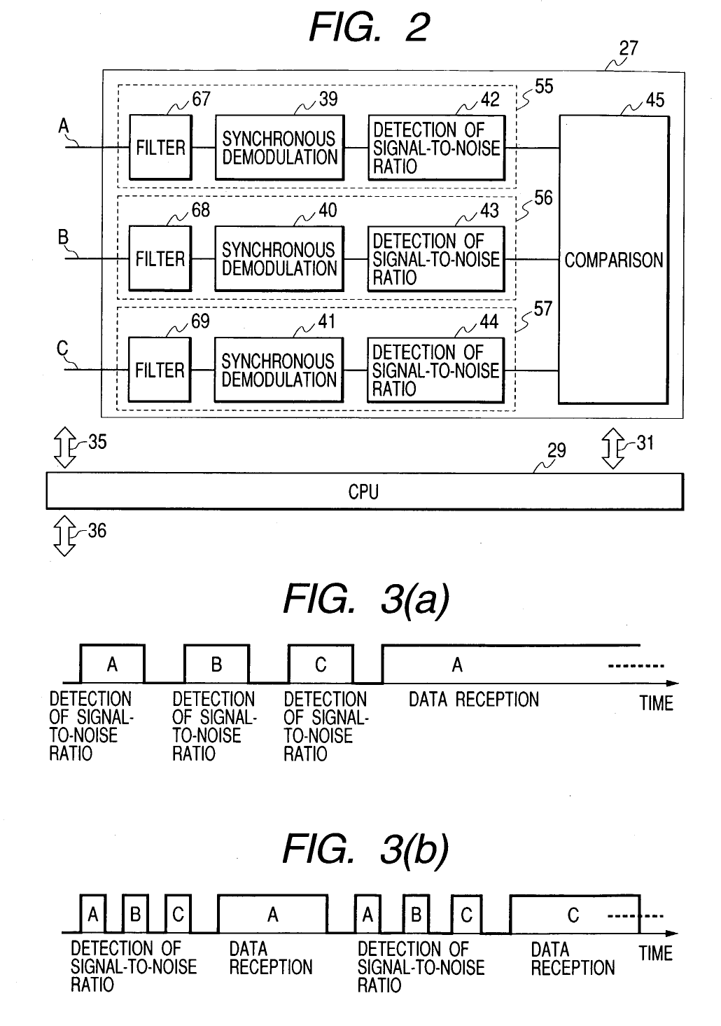

FIG. 3 shows examples of detection timing of signal-to-noise ratios of the communication systems. In a method(a), when the communication starts, signal-to-noise ratios of the communication systems A, B, C are sequentially detected, and the data is received using the communication system having the highest received signal-to-noise ratio. In a method(b), when the communication starts, the signal-to-noise ratios are detected, and data is received using the communication system having the highest received signal-to-noise ratio. In this case, the signal-to-noise ratio detection and data reception are periodically repeated. For example, in FIG. 3(b), the communication system A is switched to the communication system C to receive data, because a signal-to-noise ratio of the communication system C is the highest in the second signal-to-noise ratio detection.

In the method (a), decrease of the throughput can be restrained to efficiently execute communication because the signal-to-noise ratios are detected only at the start of the communication. However, when the received signal-to-noise ratio changes, it degrades. In the method (b), the signal-to-noise ratios are periodically repeated to select from the communication systems, decreasing the throughput. However, the good reception status can be kept even when the signal-to-noise ratio changes.

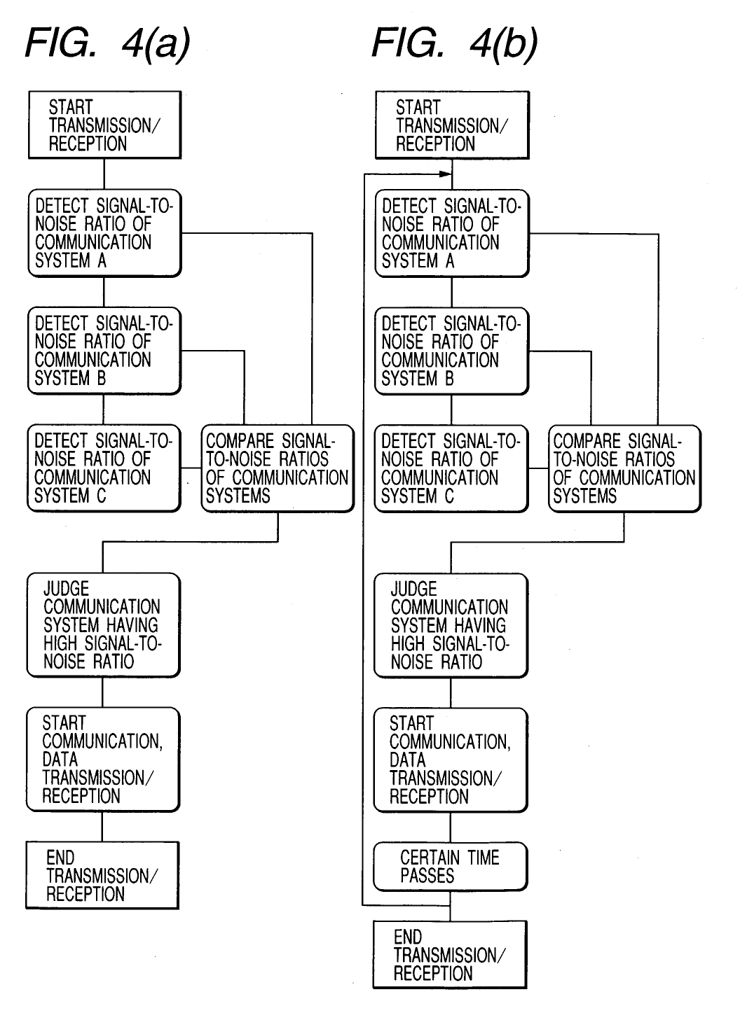

FIG. 4 shows flowcharts of a procedure of this embodiment. FIG. 4(a) shows a flowchart of the signal-to-noise ratio detection method shown in FIG. 3(a). FIG. 4(b) shows a flowchart of the signal-to-noise ratio detection method shown in FIG. 3(b). In the method (a), after the transmission/reception starts, an area signal transmitted from the base station or challenge text transmitted from the access point is received through each communication system, and a received signal-to-noise ratio of each communication system is detected. The received signal-to-noise ratios are compared, and the communication system having the highest received signal-to-noise ratio is selected to start data transmission/reception. In the method (b), when a predetermined time passes after the start of the data transmission/reception, received signal-to-noise ratios of the communication systems are compared again, and the communication system having the highest received signal-to-noise ratio is reselected. This operation is repeated until the transmission/reception ends.

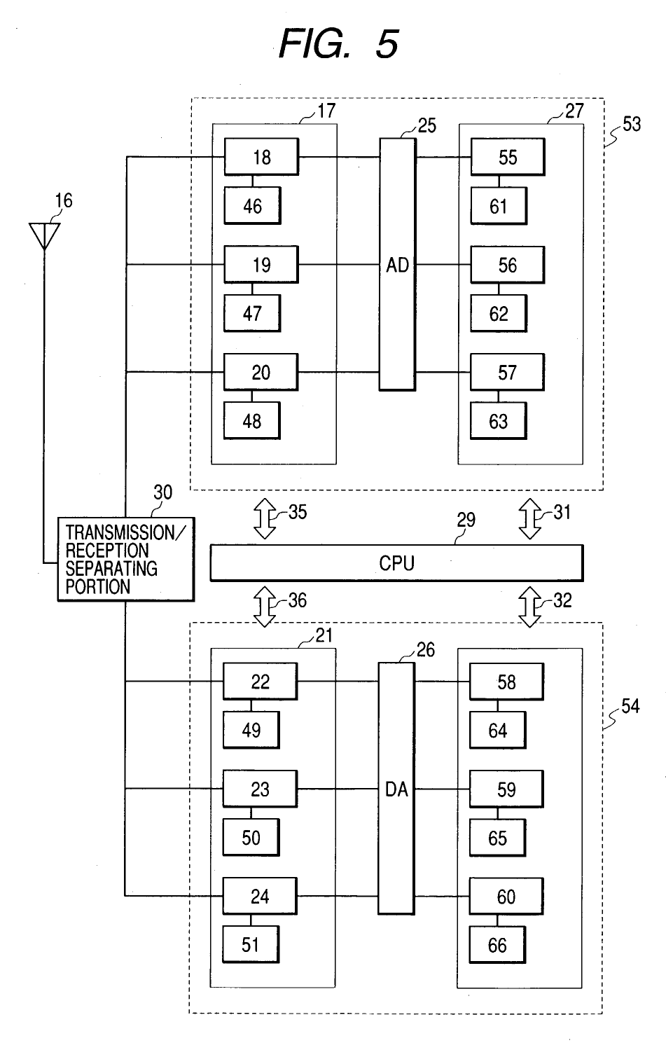

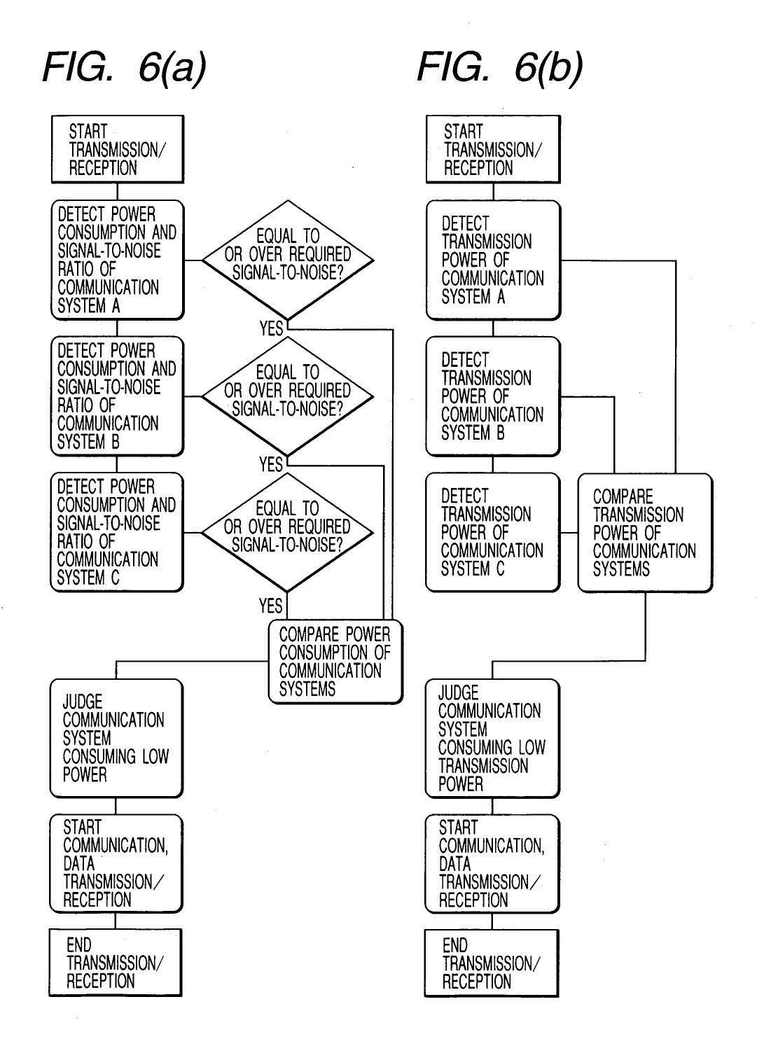

A second embodiment will be explained with reference to FIGS. 5 and 6.

FIG. 5 shows a configuration of this embodiment. Because the blocks having the same numbers as ones of FIG. 1 operate in the same way as the first embodiment, the explanation of these blocks will be omitted. A radio communication apparatus of this embodiment comprises detecting portions 46, 47 and 48 for detecting power consumed in high frequency signal processing portions 18, 19 and 20, detecting portions 61, 62 and 63 for detecting power consumed in demodulating portions 55, 56 and 57, detecting portions 64, 65 and 66 for detecting power consumed in modulating portions 58, 59 and 60, and detecting portions 49, 50 and 51 for detecting power consumed in transmitting portions 22, 23 and 24.

The modulating portions 55, 56 and 57 judge whether received signal-to-noise ratios of the communication systems are equal to or over a required signal-to-noise ratio. When the received signal-to-noise ratios are equal to or over the required signal-to-noise ratio, the CPU 29 selects, according to information from the power consumption detecting portions 46, 47, 48, 61, 62 and 63, the high frequency signal processing portion and demodulating portion corresponding to the communication system which consumes the least power, and controls them to receive data. Additionally, the CPU 29 selects, according to information from the power consumption detecting portions 49, 50, 51, 64, 65 and 66, the modulating portion and transmitting portion corresponding to the communication system which consumes the least power, and controls them to transmit data.

According to this embodiment, the low power consumption can be achieved by providing the power consumption detecting portions and executing transmission/reception by use of the communication system which consumes the least power.

FIG. 6 shows flowcharts of the second embodiment.

First, the flowchart (a) will be explained. Area signals transmitted from the base station are received through the communication systems, and received signal-to-noise ratios of the communication systems are detected. The received signal-to-noise ratios and a required signal-to-noise ratio are compared. When the received signal-to-noise ratios are equal to or over the predetermined signal-to-noise ratio, power consumption amounts of the communication systems are compared, and the communication system which consumes the least power is selected to transmit/receive data. In such a method, power consumption can be restrained with maintaining communication quality of a predetermined level.

The flowchart (b) shows a method where power consumption of the communication systems are compared, and the communication system which consumes the least power executes transmission/reception. In this method, although-the communication quality may decrease, the power consumption can be further restrained.

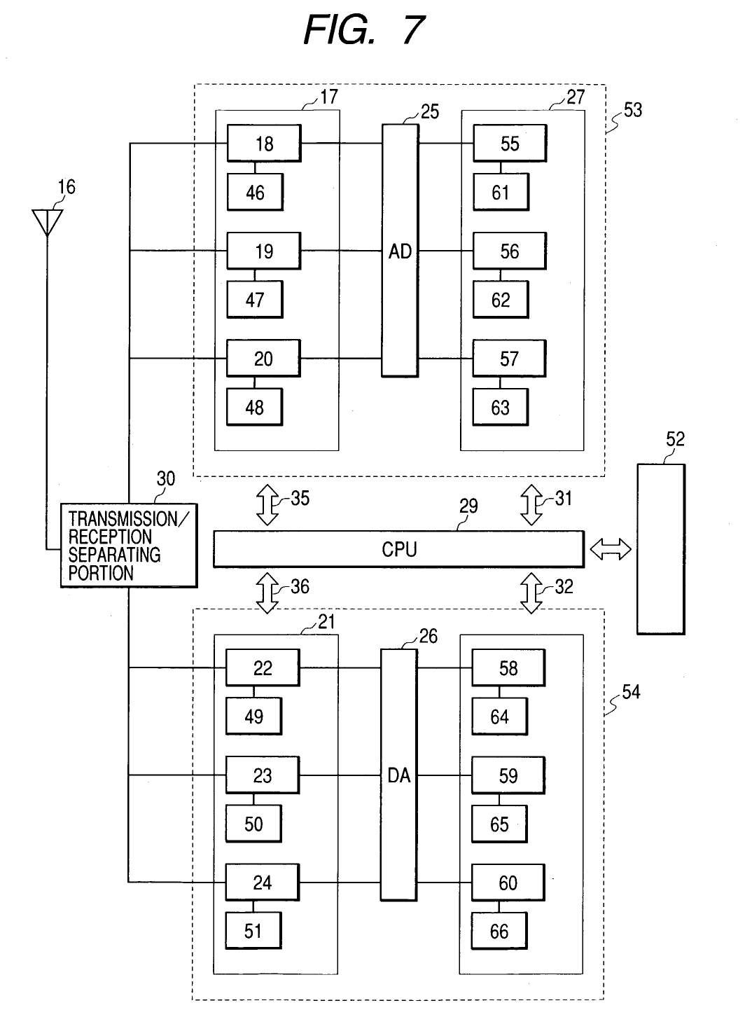

FIG. 7 shows a third embodiment. Because the blocks having the same numbers as ones of FIG. 5 operate in the same way as the second embodiment, the explanation of these blocks will be omitted. The CPU 29 detects a remaining charged amount of a battery 52. When the amount is equal to or over a reference value, the communication system having the highest received signal-to-noise ratio is selected as the receiving communication system. When the amount is equal to or under the reference value, the communication system which consumes the least power is selected as the receiving communication system. In this embodiment, when the remaining charged amount is large, the communication system having a high received signal-to-noise ratio is selected to receive data stably. When the remaining charged amount is small, the communication system consuming small power is selected to extend a data reception time.

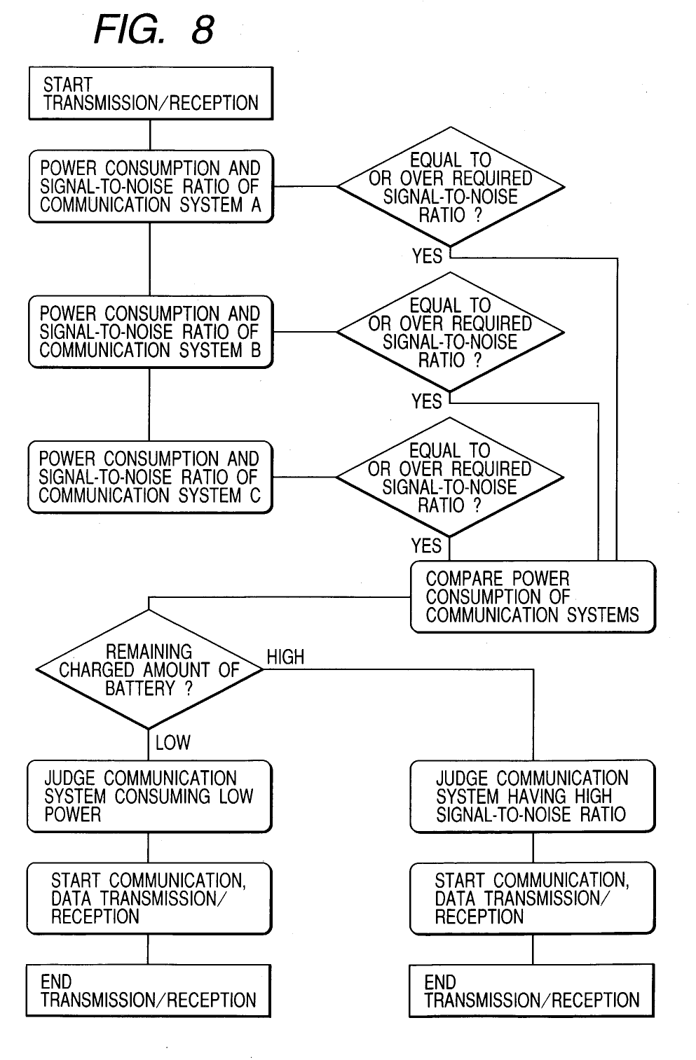

FIG. 8 shows flowcharts of the third embodiment. In this embodiment, after received signal-to-noise ratios of the communication systems are compared with a predetermined signal-to-noise ratio, and after power consumption of the communication systems are compared, a remaining charged amount of a battery is detected. When the amount is large, the communication system having a high received signal-to-noise ratio is selected to start receiving data. When the amount is small, the communication system consuming the least power is selected to start receiving data.

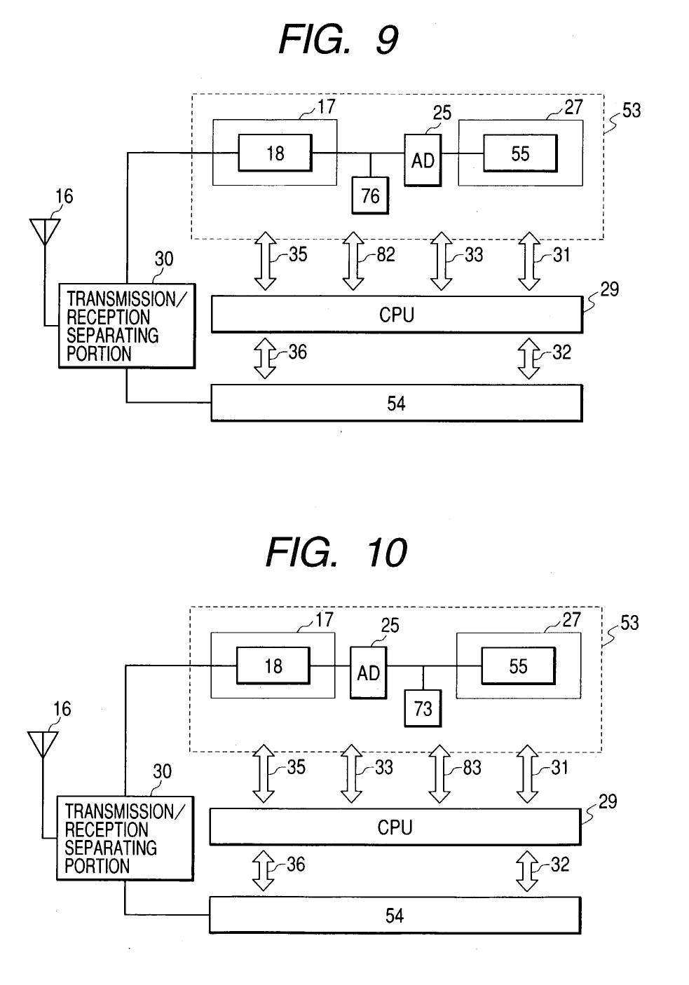

FIG. 9 shows a forth embodiment. Because blocks having the same numbers as in FIG. 1 are the same way as ones of the first embodiment, the explanation of these blocks will be omitted.

An amplitude detecting portion 76 detects an RMS (Root Mean Square) value of a signal amplitude which is input into the AD converter 25. The CPU 29 controls, according to the detection level, the number of quantization bits of the AD converter 25 and the number of processing bits of the demodulation processing portion 55 via the control buses 31, 33 and 35.

The detection level in the amplitude detecting portion 76 becomes high when an interference signal is large, and becomes low when the interference signal is small. The interference signal includes a signal of an adjacent channel. When the detection level in the amplitude detecting portion 76 is high, the CPU 29 properly changes the number of processing bits to increase the number of quantization bits of the AD converter 25 and the number of processing bits of the demodulation processing portion 55. When the detection level in the amplitude detecting portion 76 is low, the CPU 29 properly changes the number of processing bits to decrease the number of quantization bits of the AD converter 25 and the number of processing bits of the demodulation processing portion 55. For example, the number of processing bits and the number of taps are changed in a digital filter 67 of the demodulation processing portion 55.

In the AD converter 25 and demodulation processing portion 55, low power is consumed when the number of quantization bits and the number of processing bits are smaller. Therefore, in this embodiment, the number of bits is properly changed to achieve low power consumption.

FIG. 10 shows a fifth embodiment. Because the blocks numbered in the same way as in FIG. 9 are the same as ones of the forth embodiment, the explanation of these blocks will be omitted. This embodiment is different from the forth embodiment in that an amplitude detecting portion 73 is placed after the AD converter 25.

The amplitude detecting portion 73, which is placed after the AD converter 25, can detect an RMS value of a signal amplitude by use of a digital signal which is output from the AD converter 25. Because a digital signal hardly receives influence of, e.g., temperature characteristic, compared to the analog signal before being input into the AD converter 25, a more accurate value can be detected with almost no error.

When a received signal is extremely large, the AD converter 25 may saturate. In this case, as shown in FIG. 9, the amplitude detecting portion 76 is preferably placed before the AD converter 25 in order to detect an accurate RMS value.

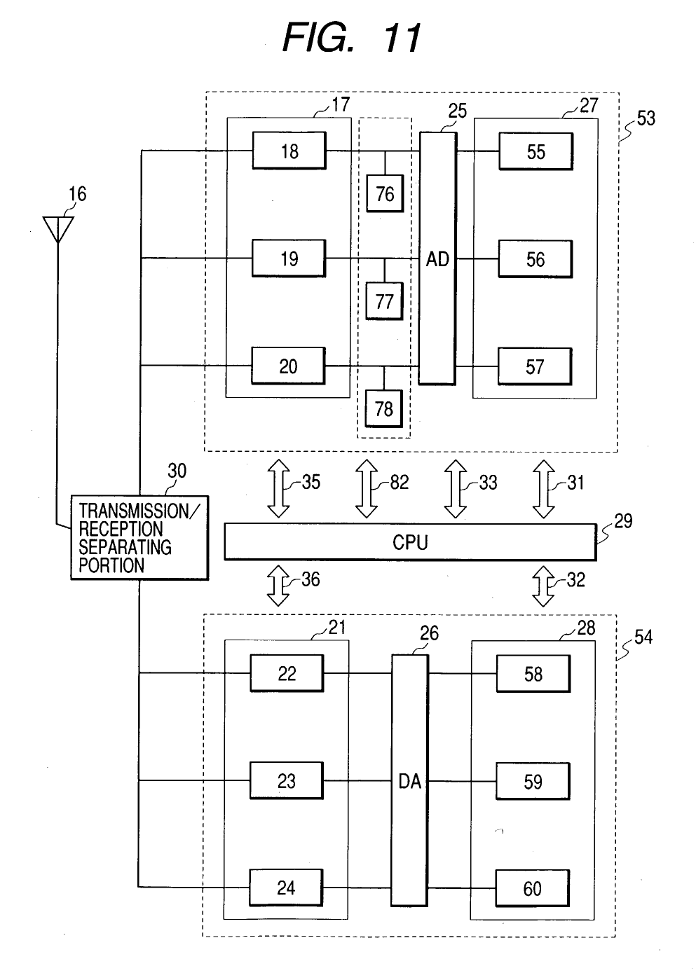

FIG. 11 shows a sixth embodiment. Because the blocks numbered in the same way as in FIGS. 1, 9 are the same as ones of the first and forth embodiments, the explanation of these blocks will be omitted. In FIG. 11, amplitude detecting portions 76, 77 and 78 are provided for output portions of high frequency signal processing portions 18, 19 and 20 of communication systems for detecting an RMS value of a signal amplitude which is input into the AD converter 25.

The CPU 29 selects the communication system having the lowest of the detection levels in the amplitude detecting portions 76, 77 and 78, and selects the high frequency signal processing portion and demodulating portion corresponding to the selected communication system. Additionally, the CPU 29 controls the number of quantization bits of the AD converter 25 and the number of processing bits of the demodulation processing portion. When a signal amplitude which is input into the AD converter 25 is small, the number of required bits becomes small. As a result, the communication system having a small signal amplitude is selected to decrease the number of bits and to save power consumption.

In this embodiment, the amplitude detecting portions 76, 77 and 78 are provided before the AD converter 25, and detect an RMS value of a signal amplitude prior to being input into the AD converter 25. The amplitude detecting portions 76, 77 and 78 may be provided after the AD converter 25, and detect a signal amplitude after being output from the AD converter 25. In this case, as described in the fifth embodiment, an accurate value can be detected with almost no error.

As described above, although the methods for selecting from three communication systems are explained, the present invention is not limited to these methods. When high frequency signal processing portions, demodulating portions, modulating portions, and transmitting portions corresponding to other types of communication systems are provided, the present invention is applicable to over three types of communication systems.

According to the above-described embodiments, reliable and steady communications can be achieved by providing means for detecting received signal-to-noise ratios of a plurality of communication systems, and by selecting the communication system having the highest received signal-to-noise ratio. Additionally, transmission/reception can be stabilized and power can be saved by providing means for detecting power consumption of transmission/reception circuit portions of the communication systems, and by selecting the communication system having the received signal-to-noise ratio equal to or over a required signal-to-noise ratio and consuming the least power. When an interference level is large, an RMS value of an amplitude level of an input or output of an AD converter becomes high. As a result, means for controlling the number of quantization bits of the AD converter and the number of processing bits of the digital signal processing circuit according to the amplitude level is provided to save power consumption.

The foregoing invention has been described in terms of preferred embodiments. However, those skilled, in the art will recognize that many variations of such embodiments exist. Such variations are intended to be within the scope of the present invention and the appended claims.

What is claimed is:

1. A radio communication apparatus comprising:
a receiver for corresponding to a plurality of communication systems;
a reception detector which detects reception statuses of the plurality of communication systems;
a power detector which detects power consumption amounts of the plurality of communication systems; and
a controller which controls the receiver to receive data by using one communication system selected from the plurality of communication systems according to the detected reception statuses and power consumption amounts.

2. A radio communication apparatus according to claim 1, wherein the reception detector detects a received signal-to-noise ratio of a signal received by the receiver.

3. A radio communication apparatus according to claim 2, wherein, when received signal-to-noise ratios of equal to or over a predetermined value are detected in a plurality of communication systems, the controller controls the receiver to receive data by use of a communication system which consumes the least power of the communication systems having the received signal-to-noise ratios of equal to or over the predetermined value.

4. A radio communication apparatus according to claim 2, wherein the reception detector detects received signal-to-noise ratios of the plurality of communication systems when the receiver starts to receive signals.

5. A radio communication apparatus according to claim 2, wherein the reception detector periodically detects received signal-to-noise ratios of the plurality of communication systems after the receiver starts to receive signals.

6. A radio communication apparatus according to claim 2, wherein the power detector detects power consumption amounts of the plurality of communication systems when the receiver starts to receive signals.

7. A radio communication apparatus according to claim 2, wherein the power detector periodically detects power consumption amounts of the plurality of communication systems after the receiver starts to receive signals.

8. The radio communication apparatus according to claim 1, wherein the radio communication apparatus comprises a battery and a battery detector which detects a remaining charged amount of the battery, and
wherein the controller controls the receiver to receive data by use of a communication system having the best of the reception statuses when the charged amount of the battery detected by the battery detector is over a predetermined amount, and to receive data by use of a communication system consuming the least power when the charged amount is equal to or under a predetermined amount.

9. A radio communication apparatus according to claim 2, wherein the radio communication apparatus comprises a battery and a battery detector which detects a remaining charged amount of the battery, and
wherein the controller controls the receiver to receive data by use of a communication system having the highest of the received signal-to-noise ratios when the remaining charged amount of the battery detected by the battery detector is over a predetermined amount, and to receive data by use of a communication system consuming the least power of the communication systems having the received signal-to-noise ratios of equal to or over the predetermined value when the remaining charged amount is equal to or under a predetermined amount.

10. A radio communication apparatus according to claim 1, wherein the receiver comprises a processor which processes an analog high frequency signal, an AD converter which converts an analog signal to a digital signal, and a demodulator which processes a digital signal,
wherein the radio communication apparatus comprises a detector which detects a signal amplitude of an input or output signal of the AD converter, and
wherein the controller controls to receive data a communication system having the least of signal amplitudes detected by the detector.

11. A radio communication apparatus according to claim 10, wherein the controller controls the number of quantization bits of the AD converter and the number of process bits of the demodulator to change according to detection levels of the detector.

12. A radio communication apparatus comprising:
a transmitting/receiving portion for corresponding to a plurality of communication systems;
a transmission/reception detecting portion for detecting transmission or reception statuses of the plurality of communication systems;
a power detecting portion for detecting power consumption amounts of the plurality of communication systems; and
a controlling portion for controlling the transmitting/receiving portion to correspond to one of the plurality of communication systems according to the detected transmission/reception statuses and the detected power consumption amounts.

13. A radio communication apparatus according to claim 12, wherein the transmission/reception detecting portion periodically detects transmission or reception statuses of the plurality of communication systems, and wherein the power detecting portion periodically detects power consumption amounts of the plurality of communication systems.

14. A radio communication apparatus according to claim 12, wherein the transmission/reception detecting portion detects a received signal-to-noise ratio of a signal received by the transmitting/receiving portion, and
wherein, when received signal-to-noise ratios of equal to or over a predetermined value are detected in a plurality of communication systems, the controlling portion controls the transmitting/receiving portion to transmit or receive data by use of a communication system which consumes the least power of the communication systems having the received signal-to-noise ratios of equal to or over a predetermined value.
